(19) United States
(12) Patent Application Publication
(10) Pub. No.: US 2011/0319089 A1
(43) Pub. Date: Dec. 29, 2011

(54) UNIVERSAL MOBILE MANAGER INTERWORKING TO SUPPORT GLOBAL ROAMING

(76) Inventors: ALOK SHARMA, Lisle, IL (US); Yigang Cai, Naperville, IL (US)

(21) Appl. No.: 12/823,390

(22) Filed: Jun. 25, 2010

(51) Int. Cl. H04W 40/00; H04L 12/56

(52) U.S. Cl. 455/445; 370/401

(57) ABSTRACT

The present invention provides a method of interworking to support global roaming across circuit-switched and packet-switched domains. Embodiments of the methods include selecting a first routing number that identifies the mobility manager as a gateway to the originating domain. The selection is performed at a mobility manager in response to receiving a request from a first gateway in an originating domain to locate a user. Embodiments of the method further include identifying a second gateway that serves the user in a destination domain using a first user identifier included in the request received from the first gateway. Embodiments of the mobility manager can store information associating the first routing number with a second routing number that identifies the second gateway.

### CROSS REFERENCE TO RELATED APPLICATIONS

This application is related to U.S. patent application Ser. No. 12/823,371 entitled, “UNIVERSAL MOBILE MANAGER INTERWORKING FOR SHORT MESSAGE SERVICE FEATURE PARITY,” filed on Jun. 25, 2010.

### BACKGROUND OF THE INVENTION

1. Field of the Invention

This invention relates generally to communication systems, and, more particularly, to wireless communication systems.

2. Description of the Related Art

Wireless communication standards are in a near constant state of flux. First-generation (1G) analog transmission gave way to digital transmission defined by second generation (2G) standards such as CDMA and GSM. Third-generation (3G) standards introduced multimedia support for voice and data transmissions, as well as spread-spectrum transmission. The next major shift in wireless communication (as defined by fourth-generation 4G standards) is from the circuit-switched protocols used in 2G/3G systems to all Internet Protocol (IP) packet-switched networks such as Long Term Evolution (LTE) and WiMAX. 4G networks typically also utilize the IP Multimedia Subsystem (IMS) architectural framework for delivering all the media services. The evolution of the wireless communication standards has implications on both the network side and the user side.

On the network side, the costs of completely switching from one standard to another are prohibitive. For example, completely switching from 2G to 3G would require abandoning all functioning 2G network elements, replacing them with 3G having equivalent or better coverage, and then asking all subscribers to switch to the new upgraded user equipment. This is clearly impractical and so the wireless network environment is a heterogeneous mix of 2G/3G networks. Furthermore, service providers are evolving towards all-IP IMS networks but the transition from circuit-switched to packet-switched networks will take years to complete. In the meantime, service providers attempt to provide subscribers with seamless service access across available circuit-switched networks, packet-switched networks, wireline networks, wireless networks, core networks, access networks regardless of the user's current location, active devices, or access network technology.

On the user side, many subscribers have upgraded to dual-mode or multiple-mode user equipment to take advantage of the different available networks. For example, a dual-mode mobile unit may be able to communicate over both a WiFi network and a CDMA network. The dual-mode mobile unit may use the WiFi access to provide wireless connectivity using a WiFi access point in the user's home and the CDMA network when the user is roaming outside of the home. Dual-mode or multiple-mode mobile units are currently required to register before using the different networks. For example, a dual-mode mobile unit needs to register with multiple networks when it is going to roam from one network to another network, e.g., from a 2G CMDA 1x network to a 4G High Rate Packet Data (HRPD) network. The multiple registrations must be performed independently because packet-switched networks and circuit-switched networks do not support a common subscriber registration process. For example, a home subscriber service (HSS) in an IMS or LTE network does not support subscriber registration in circuit networks and a home location register (HLR) in a 2G/3G circuit network does not support subscriber registration in IMS and LTE networks. For another example, the HSS and the HLR don't associate with the WiFi/WiMax registration via AAA or with the PHS registration via PHS-subscriber database and so on.

FIG. 1 conceptually illustrates a conventional wireless communication system 100 that supports roaming between the different types of networks using multiple registrations with different networks. In the illustrated embodiment, a mobile unit 105 is a multi-mode device that supports dual mode VOIP over HRPD and CDMA 3G-1X circuit mobile communication. The VoIP over HRPD (EVDO) communication presents challenges to the IMS circuit roaming architecture. In HRPD, the standards allow the HRPD user 105 to be registered with a HRPD RAN 110 and also be concurrently registered in a radio access network 115 that is connected to a circuit-switched network mobile switching center 120. The registration in the circuit-based MSC 120 is called a tunneled registration and it can be used for SMS and message waiting indication delivery. SMS and MWI get forwarded by the circuit-based MSC RAN 115 to the HRPD RAN 110 via a tunnel 125. An HLR 130 would therefore see the user 105 registered in a circuit-based MSC 120 at the same that the user 105 may be using VOIP over HRPD via the radio access network 110, which doesn't have an MSC. Communication in a system 100 may also utilize an IMS media gateway 145, a public switched telephone network (PSTN) 150, and a gateway mobile switching center (G-MSC) 155.

The HRPD dual registration therefore has 3 basic registrations that are required for the interworking between the HRPD (1XEVDO), 3G-1X, and IMS networks for the dual mode mobile unit 105 to use VOIP over HRPD and CDMA 3G-1X circuit mobile communication. First, the mobile unit 105 sends a HRPD Registration at connection setup to an AAA server 130 via a Packet data switch node (PDSN) 135 and a wide area network 140. Second, the mobile unit 105 sends an additional IMS Registration to a HSS and VOIP App Server, which in this case is implemented in the same physical server 130. The VOIP App Server also subscribes to call delivery events at HSS/HLR 130. Third, the mobile unit 105 performs a 3G-1X registration with the HLR 130 to allow for 3G1X Circuit Services Notification Application, which may also be referred to as cross paging application. This registration allows for delivery of 3G1X voice call pages while on HRPD Traffic Channel, delivery of SMS and other data burst messages while on HRPD Traffic Channel, permits the mobile unit 105 to drop to monitoring only 3G1X while still supporting push data on HRPD. The multiple registration messages represent additional overhead.

Furthermore, coordinating communication between the multiple networks/registrations is complicated, especially when it's not clear whether the user's directory number is owned by the IMS, VoIP MVNO or circuit network and whether or not the routing entry point for the subscriber is through IMS or traditional network. For example, the owner of the directory number may be uncertain or unknown when considering how to achieve call delivery from the circuit-switched CDMA network into the packet-switched IMS network. Traditional call delivery methods for circuit-switched networks depend on the last seen pointer in the HLR 130 pointing to the MSC 120 where the user 105 is registered for call delivery. But in the case of VOIP over HRPD over IMS, the user 105 would like voice calls delivered to the IMS and not to the circuit-based MSC 120 that has his tunneled registration. Therefore, the conventional IMS/ASNI interworking architecture, where the IMS appears to the HLR 130 as a visited MSC, would not work for VOIP over HRPD, even if there was an ANSI-41 interface directly on the Mobility Manager Application Server (HSS) in the IMS. This is because the HLR registration must point to a real MSC with a real CDMA 1X RAN that has a tunnel to the HRPD RAN, such as the tunnel 125.

Similar problems occur when attempting to interwork new 4G packet-switched networks with existing 2G/3G circuit-switched networks. Current standards and/or protocols support pure HSS functionality for mobile subscriber data management in IMS and LTE networks. However, the HSS defined by conventional standards does not support interworking with cellular HLR/MSC entities for roaming service between the IMS/LTE and 2G/3G cellular networks. Moreover, new service providers like cable operators and mobile virtual network operators (MVNOs) may use different communication models than the incumbent wireless service providers. For example, new service providers may deploy new 4G networks that own the directory numbers (DNs) for subscribers to the new 4G networks. In that case, the existing 2G/3G network is not the owner of the directory number (DN) for subscribers to the 4G networks. The subscriber DN belongs to the IMS. Therefore, the new service providers may need to initiate roaming call delivery from IMS into CDMA, which may be a different model than incumbent wireless providers who initiate call delivery from CDMA into IMS.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for interworking to support global roaming across circuit-switched and packet-switched domains. Embodiments of the methods include selecting a first routing number that identifies the mobility manager as a gateway to the originating domain. The selection is performed at a mobility manager in response to receiving a request from a first gateway in an originating domain to locate a user. Embodiments of the method further include identifying a second gateway that serves the user in a destination domain using a first user identifier included in the request received from the first gateway. Embodiments of the mobility manager can store information associating the first routing number with a second routing number that identifies the second gateway.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a conventional wireless communication system that supports roaming between the different types of networks using multiple registrations with different networks;

FIG. 2 shows one exemplary embodiment of a wireless communication system that supports a dual mode mobile roaming between an Internet Protocol (IP) Multimedia Subsystem/Long Term Evolution (IMS/LTE) network and a Code Division Multiple Access/Global System for Mobile communication (CDMA/GSM) circuit-switched network;

FIG. 3 conceptually illustrates one exemplary embodiment of a universal mobility manager that supports integrated home location register and home subscription servers;

FIG. 4 conceptually illustrates an exemplary embodiment of a network architecture that implements the COPS interface;

FIG. 5 conceptually illustrates one exemplary embodiment of the message flow used to support high-level protocol independent common operations over the COPS interface;

FIGS. 6A and 6B conceptually illustrate user mobility in first and second embodiments of a communication system;

FIG. 7 conceptually illustrates global roaming in the cellular user address mode;

FIG. 8 conceptually illustrates communication pathways in one exemplary embodiment of a wireless communication system;

FIG. 9 conceptually illustrates communication pathways in a second exemplary embodiment of a wireless communication system;

FIG. 10 conceptually illustrates one exemplary embodiment of a call flow that supports roaming control;

FIG. 11 conceptually illustrates one exemplary embodiment of a call flow to handle late call forwarding;

FIG. 12 conceptually illustrates global roaming using the IMS address mode;

FIG. 13 conceptually illustrates communication pathways in a wireless communication system;

FIG. 14 conceptually illustrates a first exemplary embodiment of a method for roaming control between LTE/IMS and cellular networks in the IMS user access mode;

FIG. 15 conceptually illustrates a second exemplary embodiment of a method for roaming control between LTE/IMS and cellular networks in the IMS user access mode;

FIG. 16 conceptually illustrates a third exemplary embodiment of a method for roaming control between LTE/IMS and cellular networks in the IMS user access mode;

FIG. 17 conceptually illustrates a fourth exemplary embodiment of a method for roaming control between LTE/IMS and cellular networks in the IMS user access mode;

FIG. 18 conceptually illustrates a fifth exemplary embodiment of a method for roaming control between LTE/IMS and cellular networks in the IMS user access mode;

FIG. 19 conceptually illustrates a sixth exemplary embodiment of a method for roaming control between LTE/IMS and cellular networks in the IMS user access mode;

FIG. 20 conceptually illustrates a seventh exemplary embodiment of a method for roaming control between LTE/IMS and cellular networks in the IMS user access mode;

FIG. 21 conceptually illustrates an eighth exemplary embodiment of a method for roaming control between LTE/IMS and cellular networks in the IMS user access mode; and

FIG. 22 conceptually illustrates one exemplary embodiment of a caller profile for a dual-mode phone with IMS and ANSI-41 capabilities.

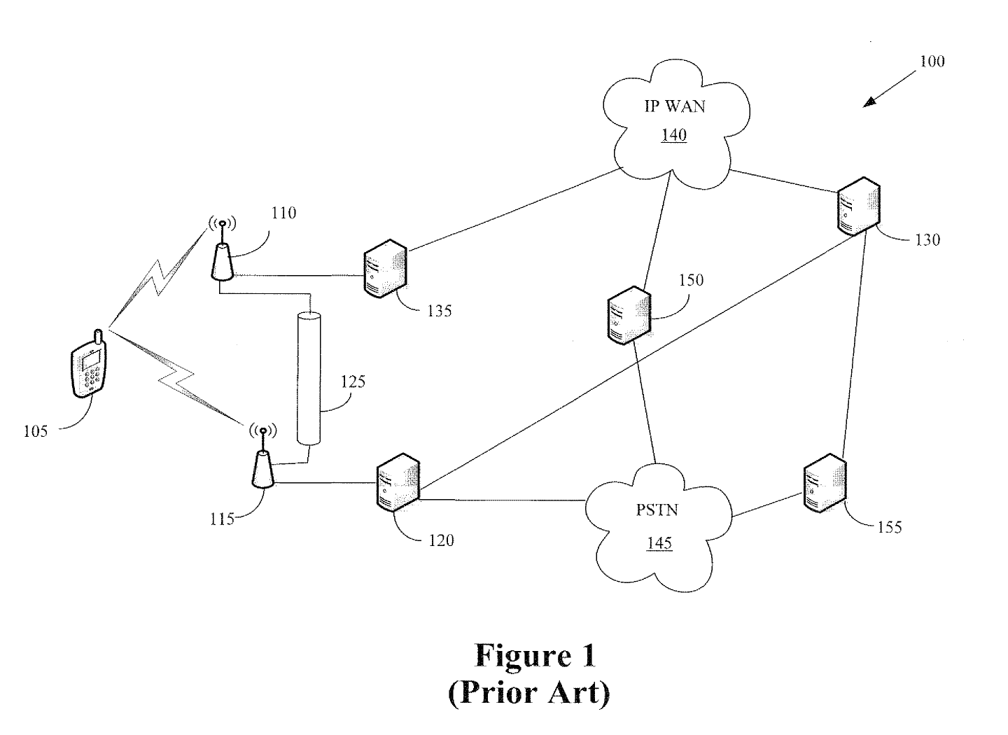

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

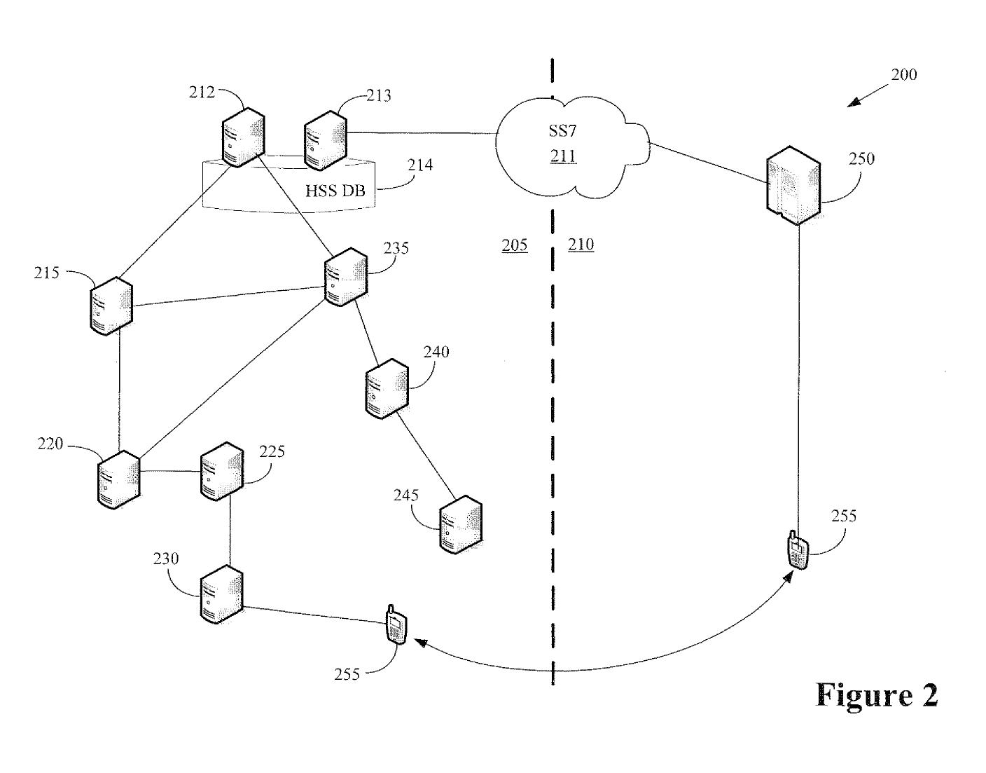

FIG. 2 shows one exemplary embodiment of a wireless communication system 200 that supports a dual mode mobile roaming between a packet-switched network 205 such as an Internet Protocol (IP) Multimedia Subsystem/Long Term Evolution (IMS/LTE) network and a circuit-switched network 210 such as a Code Division Multiple Access/Global System for Mobile communication (CDMA/GSM) network. The networks 205, 210 can communicate over an interface 211 that operates according to the well-known SS7 protocol.

The network 205 includes a home location register 212 and a home subscriber server 213 that can access profiles stored in a database 214. A Home Location Register (HLR) is the main database of permanent subscriber information for a mobile network. The HLR is an integral component of CDMA (code division multiple access), TDMA (time division multiple access), and GSM (Global System for Mobile communications) networks. Each subscriber's home carrier maintains an HLR (or the network operator where the user initiated the call) and the HLR contains pertinent user information, including address, account status, and preferences. The Home Subscriber Server (HSS), or User Profile Server Function (UPSF), is a master user database that supports the IMS network 205 entities that actually handle calls. It contains the subscription-related information (subscriber profiles), performs authentication and authorization of the user, and can provide information about the subscriber's location and IP information. It is similar to the GSM Home Location Register (HLR) and Authentication Centre (AUC).

The network 205 also includes a short message service center (SMSC) 215 and call session control functions including a serving call session control function (S-CSCF) 220 and a proxy call session control function (P-CSCF) 225. The P-CSCF 225 is responsible for interfacing directly with transport plane components and is the first point of signaling within IMS for any end-point. As the name implies, the P-CSCF 225 is a proxy for SIP messages from end-points to the rest of the IMS network. The S-CSCF 220 is responsible for interfacing with the Application Servers (AS) in the Application Plane. Upon receiving a registration request SIP message from an Interrogating-CSCF (not shown), the S-CSCF 220 can query the HSS 213 via Diameter protocol to register the terminal as being currently served by itself. The P-CSCF 225 communicates with a packet gateway 230.

Communication of short messages through the network 205 can be coordinated by a short message serving center gateway (SMS-GW) 235. For example, the network 205 may support a short message service (SMS) for transmitting short messages using the Mobile Application Part (MAP) of the SS7 protocol. Messages are sent with the MAP operations that support mobile-originated messages (e.g., SMS messages that are originated by a mobile unit) and/or mobile-terminated messages. (e.g., SMS messages terminated at a receiving mobile unit). The SMS-GW 235 also communicates with a short message peer-to-peer gateway 240 and an over-the-air server (OTA) 245. The Short Message Peer-to-Peer (SMPP) protocol used by the gateway 240 is a telecommunications industry protocol for exchanging SMS messages between SMS peer entities such as short message service centers.

The network 210 includes a GSM mobile switching center 250 that can interface with the network 205 over the SS7 interface 211. The mobile switching center 250 operates switching functions for the mobile units within its jurisdiction and supports interfaces between the mobile network 210 and other fixed or mobile networks such as the network 205. Exemplary functionality implemented in the mobile switching center 250 includes management of mobile locations, call switching, handover of mobile terminals between base station controllers and the network 210, resource management, and interworking with network databases such as home location registers, the visitor location registers, and authentication centers in the network 210.

Mobile unit 255 is a dual-mode or multiple-mode device is capable of communicating with either of the networks 205, 110. The mobile unit 255 may therefore roam between the networks 205, 210 and hand off between base stations and/or access points that provide wireless connectivity to the networks 205, 210. The SMS gateway 235 has to query both the home subscriber server 212 and the home location register 213 to know the mobile destination network. The home subscriber server 212 and the home location register 213 may not know whether the mobile unit 255 has registered at either or both sides of the network. This lack of awareness can make it difficult or impossible to provide the seamless coverage expected by users in a heterogeneous network environment, at least in part because of the overhead required to locate the mobile units 255.

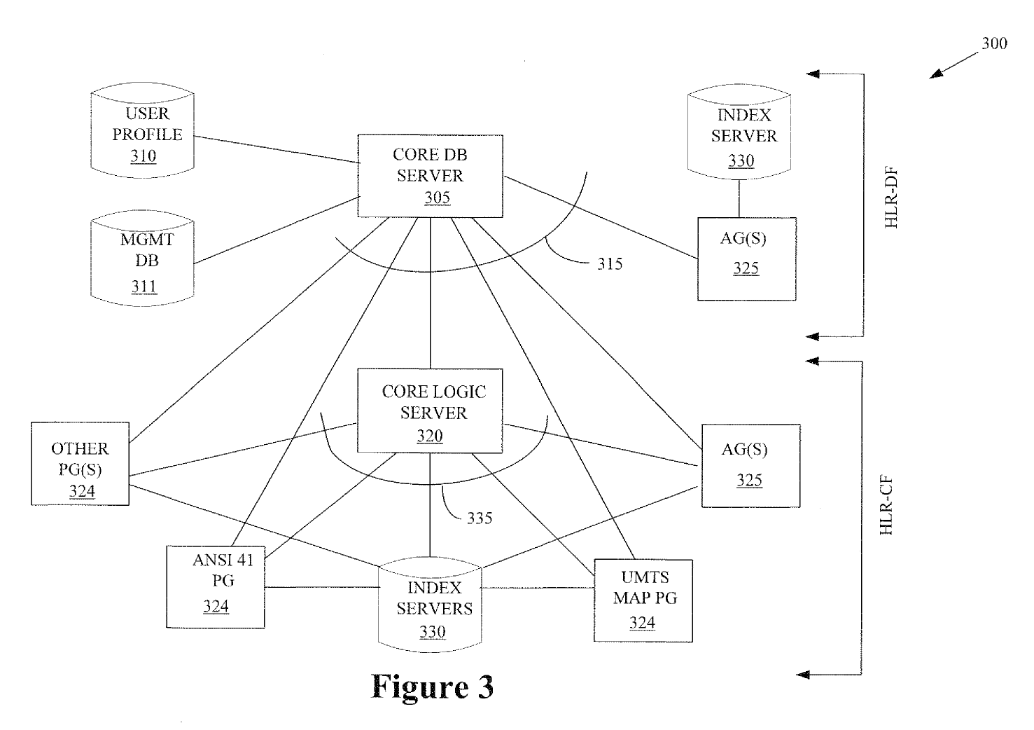

FIG. 3 conceptually illustrates one exemplary embodiment of a universal mobility manager 300 that supports integrated home location register and home subscription servers. In the illustrated embodiment, the universal mobility manager 300 can be conceptually divided into a portion that supports the home location register data functions (HLR-DF) and a portion that supports the home location register control functions (HLR-CF). The data function portion includes a core database server (CDS) 305 that manages the integrated user profile database 310 and the management database server 311. The core database server 305 also provides a database access interface 315 for other elements in the universal mobility manager 300. The core database server 305 therefore defines the data view common across protocols as well as that specific to each protocol. Core logic servers 320 are deployed in the control function portion of the universal mobility manager 300. The core logic server 320 provides protocol dependent logic servers 324 and/or application gateways 325 with the COPS interface 335. In one embodiment, the core logic servers 320 can download multi-protocol user profile information from the core database server 305.

The universal mobility manager 300 may also implement one or more application gateways 325 may be associated with different network types. The application gateways 325 may include functionality that is similar to a protocol dependent logic server, except that application gateways 325 do not deal with communication protocols, but with application protocols. For example, an application gateway 325 can support Lightweight Directory Access Protocol (LDAP) for general subscriber database access, http for end-user's web-based database access, PARLAY for new location-based service system, and so on. One or more index servers 330 may also be included in the universal mobility manager 300. Index servers 330 are used to locate an HSS/HLR-DF/CDS instance that includes user profile information of a user in question. Each index server 330 maintains a mapping table to an instance identifier from various types of user database keys employed by different protocols. Exemplary identifiers that can be used to locate user profile instances include, but are not limited to, well-known identifiers such as IMSI, MSISDN, MIN, MDN, SIP URL, and a RADIUS/DIAMETER user name. Index servers 330 accept mapping retrieval requests for CLS/PDLS/AG to find a correct HSS/HLR-DF/CDS instance. The index server 330 can then query (or provide an interface for queries from other entities) the located instance to gather information about the associated user. Each index server 330 also accepts mapping updates or erasure requests from a provisioning system to update a mapping entry, and the update can be propagated to all replica of the instance.

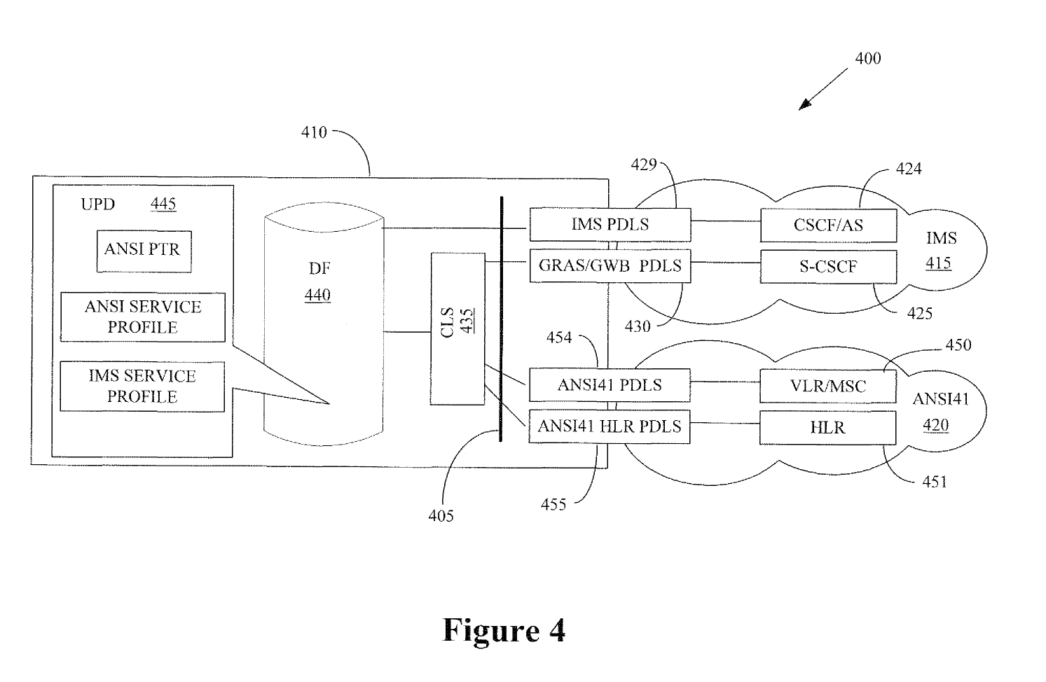

FIG. 4 conceptually illustrates an exemplary embodiment of a network architecture 400 that implements the COPS interface 405. In the illustrated embodiment, the interface 405 is implemented in a universal mobility manager 410 that is configured to coordinate the communication between an IMS network 415 and an ANSI41 network 420. Persons of ordinary skill in the art should appreciate that the embodiment shown in FIG. 4 is intended to be illustrative and not to limit the claimed subject matter. For example, in alternative embodiments the architecture 400 may be generalized to provide support for additional networks and/or additional network types.

In the illustrated embodiment, CSCF 424 and application server entities 425 in the IMS network 415 can exchange messages with the protocol dependent logic server interfaces 429, 430 that are implemented in the manager 410. The messages exchanged between the CSCF(s) 425 and the interfaces 430 are formatted according to the formats used by the IMS network 415. The interfaces 430 also communicate using these formats and so the interfaces 430 can extract or utilize information in the messages to gather user profile information for users associated with the messages by communicating with the core logic server 435 over the COPS interface 405. For example, the interfaces 430 can form database queries that are transmitted to the core logic server 435 and then onto the database function 440. Alternatively, the interfaces 430 may send the queries directly to the database function 440. The queries can be used to locate a user profile 445 that, in the illustrated embodiment, includes a pointer (ANSI PTR) that indicates that the user is currently associated with the ANSI network 420 and service profiles for both the ANSI network 420 and the IMS network 415.

A visitor location register/mobile switching center (VLR/MSC) 450 and a home location register 451 in the ANSI network 420 can exchange messages with the protocol dependent logic server interfaces 454, 455. These messages are formatted according to the formats used by the ANSI network 420. The interfaces 454, 455 may use information in these messages to query the database function 440 and/or to communicate with the core logic server 435 over the COPS interface 405.

The integrated HSS/HLR functionality in the manager 410 can support ubiquitous services across the networks. In one embodiment, the interface 430 implements a gateway broker (GWB) protocol dependent logic server (PDLS). The GWB PDLS can perform temporary local directory number (TLDN)-to-IMS public ID mapping for a cellular originated call using an ANSI41 user address (a directory number). The GWB SIP PDLS may also emulate the temporary routing number allocation activity of a serving MSC in order to achieve cellular-to-packet/IMS roaming. The GWB PDLS can maintain a pool of temporary routing numbers, called a temporary SIP gateway number (TSGN), which may be employed to route a call in a PSTN/SS7 network to the media gateway in the service provider's IMS/packet domain. In another embodiment, the interface 430 implements a global roaming application server (GRAS) with a SIP Protocol Dependent Logic Server (PDLS). The GRAS PDLS interworks with the LTE/IMS S-CSCF 425 and interfaces with the integrated HSS/HLR in the UMM 410 to support mobile roaming management. The GRAS PDLS can act as a SIP Application Server towards the LTE/IMS network via SIP protocol. Consequently, the GRAS PDLS and S-CSCF do not need to query the HSS via Diameter Sh protocol for subscriber routing between IMS/LTE and 2G/3G cellular networks.

The universal mobility manager 410 can therefore be configured to provide universal roaming and user mobility management capabilities between different networks including the IMS/LTE and 2G/3G cellular networks. In one embodiment, the universal mobility manager 410 provides the cross-domain mechanisms that support a universal roaming experience from the subscriber's perspective by providing single number service (for call delivery across protocol domains—PS, CS, wireline, wireless etc), user mobility across different device addresses, unified data experience (service profile), service ubiquity by providing access to the same services and applications, unified voice mail and notification, single bill, and the like.

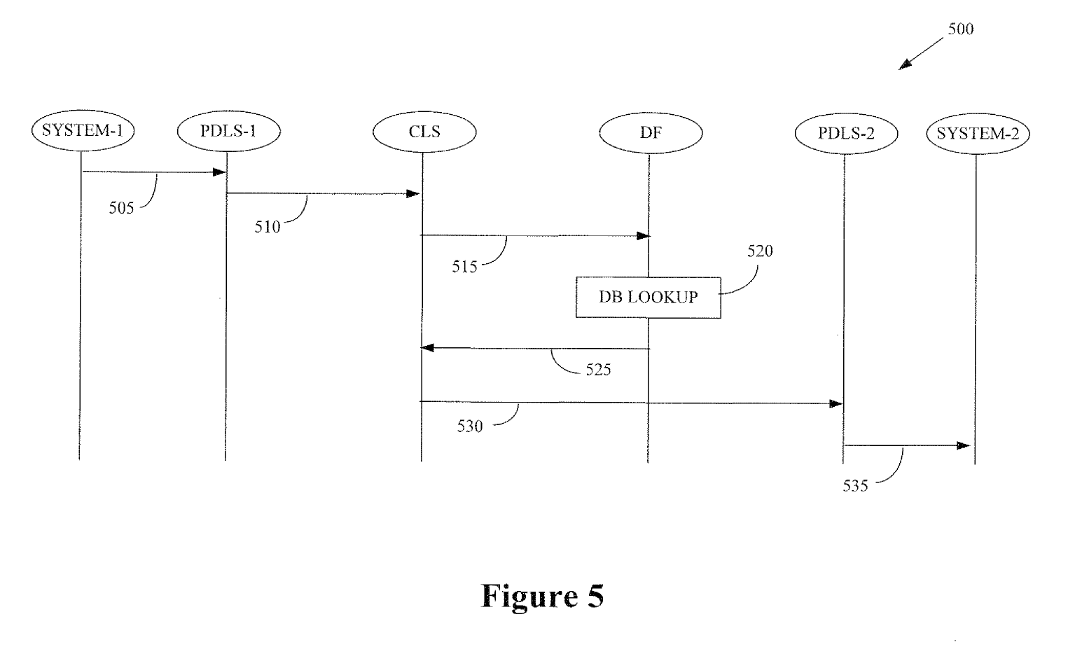

FIG. 5 conceptually illustrates one exemplary embodiment of the message flow 500 used to support high-level protocol independent common operations over the COPS interface. In the illustrated embodiment, the message flow 500 begins when an originating system (SYSTEM-1) transmits (at 505) a message to a protocol dependent location server (PDLS-1) requesting location of a destination entity. Exemplary messages include an ANSI41 locreq message, a UMTS SRI message, a SIP invite message, and the like. PDLS-1 transmits (at 510) a message including a database query over the COPS interface to the core logic server (CLS), which forwards (at 515) the database query to the database function (DF). The database function uses the query to perform (at 520) a database lookup to locate a user profile indicated in the query. For example, the database function may use a request location message that includes the user address to locate the user profile. In the illustrated embodiment, the results of the query indicate that the destination entity is in a different system (SYSTEM-2). The database function returns (at 525) the location information to the core logic server. The core logic server then transmits (at 530) a request route information (RRI) message to the protocol dependent location server (PDLS-2) that interfaces with the second system. PDLS-2 then forwards (at 635) the RRI message to SYSTEM-2.

Global roaming refers to the combination of terminal mobility (e.g., a single terminal or user equipment roaming through a communication system) and user mobility (e.g., a user roaming to different terminals in the communication system). User mobility can be supported by maintaining a notion of a user who can own several mobile or fixed terminals that are used to access the communication system. The communication system allows each user to be addressed using an address that is assigned to the user independent of any particular terminal. Additional addresses can also be assigned to specific terminals. The communication system then dynamically maps and routes a call addressed to a user to some or all of their terminals. For example, the communication system can route calls to terminals that are specified in a user's destination selection policy, which may be stored in the user's profile in the universal mobility management server.

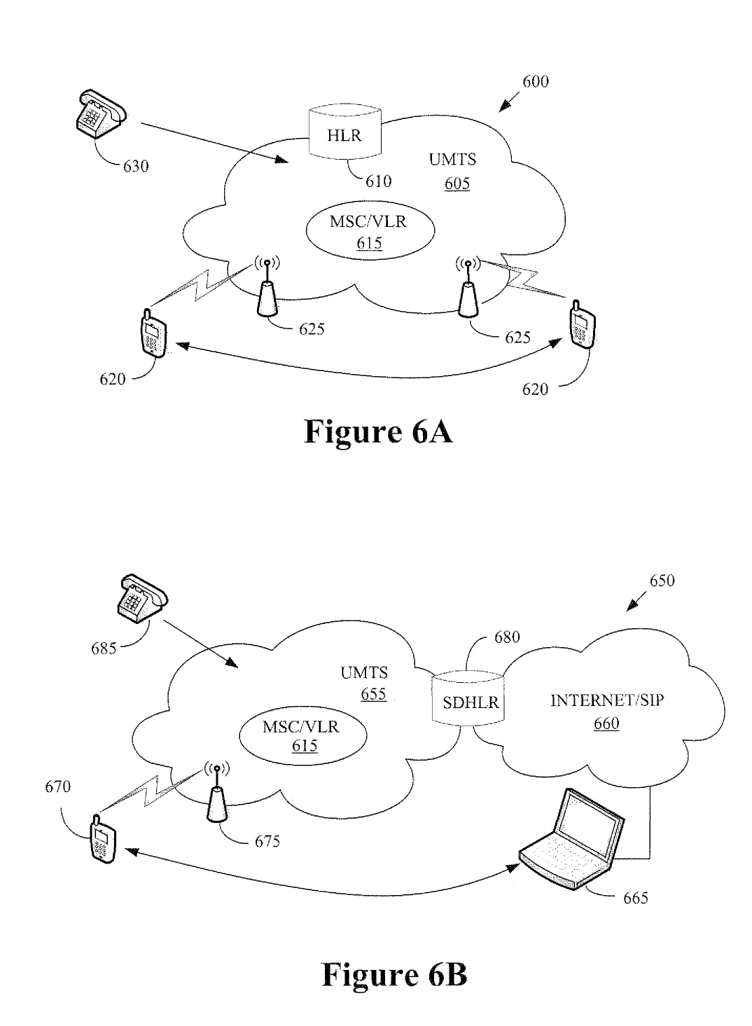

FIG. 6A conceptually illustrates terminal mobility in a first embodiment of a communication system 600. In the illustrated embodiment, the communication system 600 includes a UMTS network 605 that supports a home location register 610 and a mobile switching centers/visitor location register 615. A mobile unit 620 can roam between different cells 625 of the UMTS network 605. When a call arrives for the mobile unit 620 from a calling party 630, the UMTS network 605 uses information stored in the home location register 610 and the visitor location register 615 to route the call to the appropriate cells 625. Call routing can be performed based upon an address or identifier (such as an international mobile subscriber identity) that is assigned to the mobile unit 620.

FIG. 6B conceptually illustrates user mobility in a second embodiment of a communication system 650. In the illustrated embodiment, the communication system 650 includes a UMTS network 655 and an Internet/session initiation protocol network 660. The user has a fixed terminal 665 that is connected to the Internet and a mobile terminal 670 that can be used to connect to the UMTS network 655 via an access point 675. The fixed terminal 665 and the mobile terminal 670 may have terminal-specific addresses such as an Internet address and an IMSI, respectively. However, the user may also have an associated address to support user mobility between networks and/or terminals. The user address and be associated terminal addresses can be stored in the universal mobility manager database (SDHLR) 680 and used to route calls between the user and a calling party 685. The user may therefore use either the fixed terminal 665 for the mobile terminal 670 for the communication.

Global roaming between circuit switched networks such as 2G/3G networks and packet switched networks such as IMS/LTE may be supported using two different address modes. The different modes may allow service providers to keep (or “home”) destination numbers for dual/multiple mode subscribers. In the cellular user address mode, service providers for circuit switched networks can maintain destination numbers in the home network. In the IMS user address mode, service providers for packet-switched network can maintain the destination numbers in their home network.

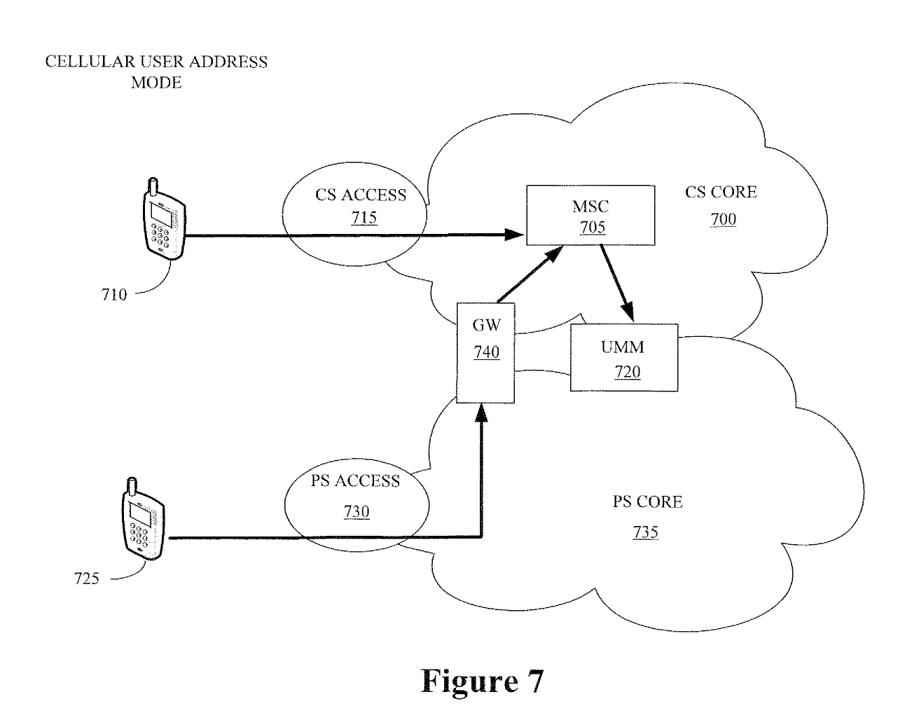

FIG. 7 conceptually illustrates global roaming using the cellular address mode. In the illustrated embodiment, subscriber destination numbers (DNs) are homed in the circuit-switched core network 700. For example, the DNs can be stored in a mobile switching center 705 in the core network 700. The mobile switching center 705 is queried when a request for a user associated with a subscriber destination number is received from a user 710 via a circuit-switched access network 715. The request can then be forwarded to the universal mobility manager 720, which can use the destination number from the circuit-switched network 700 to locate the user and one or more devices, as discussed herein. Requests from users 725 that are received via a packet-switched access network 730 and a packet-switched core network 735 can also be directed to the mobile switching center 705 using a gateway 740. The request can then be forwarded to the universal mobility manager 720.

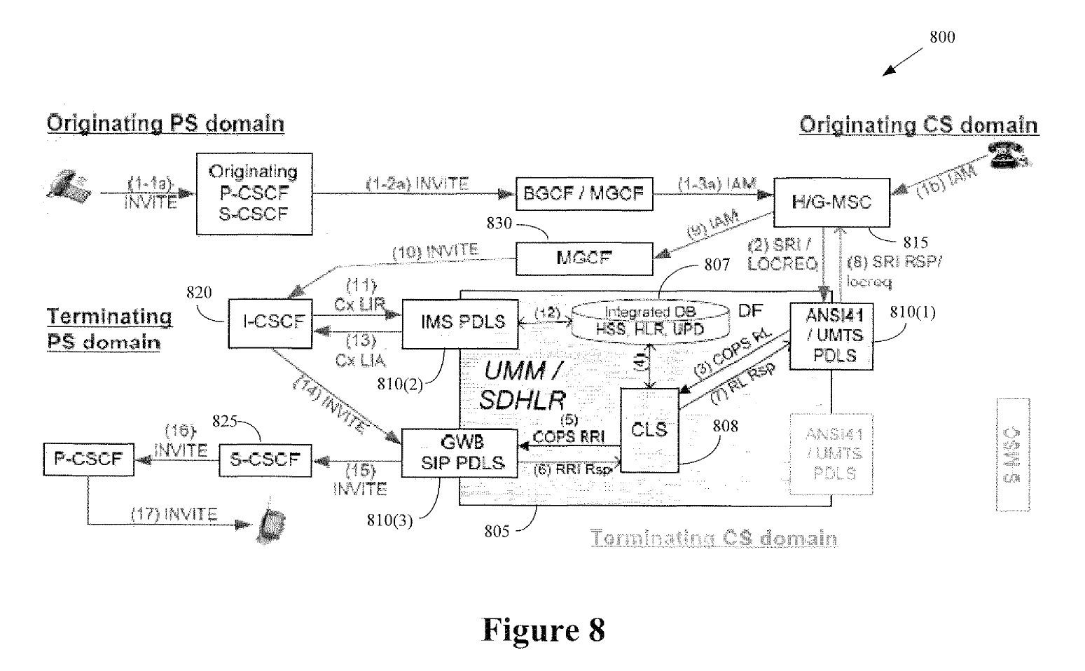

FIG. 8 conceptually illustrates communication pathways in a first exemplary embodiment of a wireless communication system 800. In the illustrated embodiment, the wireless communication system 800 includes a universal mobility manager 805 such as the universal mobility manager 300 depicted in FIG. 3. As discussed herein, the universal mobility manager 805 includes an integrated database 807 that supports HSS, HLR, and UPD functionality in a core logic server 808. The universal mobility manager 805 also includes three PDLS entities 810(1-3). The UMTS PDLS 810(1) provides an interface to a mobile switching center 815 and a circuit-switched domain, the IMS PDLS 810(2) provides an interface to the interrogating CSCF 820 in the terminating packet-switched domain, and the gateway broker (GWB) PDLS 810(3) provides an interface to the S-CSCF 825 in the terminating packet-switched domain.

The GWB PDLS 801(3) performs TLDN-to-IMS public ID mapping for a cellular originated call using an ANSI41 user address (a directory number). A TLDN is a Temporary Local Directory Number, which is a routable network address up to 15 digits in length that may be temporarily assigned to a roamer to enable their home MSC to route an incoming call via the PSTN to the visited network where the roamer is currently receiving service. The TLDN is allocated by the serving network long enough for the call to be routed and then released so that it may be reused. Roaming carriers set aside a pool of TLDNs sufficient to support the maximum number of expected concurrent inbound call termination attempts. These TLDNs can be provided to each roaming partner so that they are supported by the partner's MSC routing tables. The GWB SIP PDLS 801(3) may emulate the temporary routing number allocation activity in serving MSC in order to achieve cellular-to-packet/IMS roaming. In one embodiment, the GWB PDLS 810(3) maintains a pool of temporary routing numbers called temporary SIP gateway numbers (TSGNs). The pool of TSGNs is employed to route calls in a PSTN/SS7 network to the media gateway in the service provider's IMS/packet domain.

The GWB SIP PDLS 810(3) may perform (among other functions) the following three functions. First, upon receipt of a COPS RRI message the GWB SIP PDLS 810(3) can reserve an unused TSGN from the TSGN pool and maintain the mapping from the TSGN to the PUID, which is the destination address of the IMS terminal to be used in Request-URI. The GWB SIP PDLS 810(3) may also store information identifying the S-CSCF that currently serves the PUID. Second, upon receipt of a SIP INVITE with TEL URI with a TSGN, the GWB SIP PDLS 810(3) can search the mapping table to locate the TSGN and retrieve the related PUID and S-CSCF address. The GWB SIP PDLS 810(3) can remove the top of the Route header, which is the address of the GWB SIP PDLS, and replace the Request-URI (tel: tsgn) with the PUID and put the S-CSCF address at the top of the Route header. The GWB SIP PDLS 810(3) may then return the TSGN back to the TSGN pool. Third, if the call has LCF/LCAH activated (which the GWB SIP PDLS 801(3) could learn from COPS RRI message), the GWB SIP PDLS 810(3) can maintain the information until final response is received for the SIP INVITE or timeout happens. If a 4xx response comes back (which triggers LCF/LCAH), then the response is translated into COPS RIR (Request Inter-protocol Redirection) message.

The GWB SIP PDLS 810(3) may also emulate the temporary routing number assignment process of the 2G/3G cellular network. In cellular network, this process is performed at the serving MSC so that a call leg can be extended from the home/gateway MSC to the serving MSC using PSTN (fixed network) SS7 call-setup protocol (ISUP/TUP). In the CS-to-PS (IMS/IETF SIP) call delivery scenario depicted in FIG. 8, the GWB SIP PDLS 810(3) allocates a temporary routing number, called a temporary SIP gateway number (TSGN), to extend a call leg over PSTN from the home/gateway MSC 815 to the PSTN/SIP gateway (MGCF, MGW) 830. The GWB SIP PDLS 810(3) also maintains the mapping from TSGN to the packet destination information (contact addresses or serving CSCF addresses and so on) so that the call can be delivered to the final destination in the packet domain. A call arrives from cellular networks at UMM 805 through ANSI-41 PDLS 801(1) as an ANSI-41 LOCREQ request. A COPS RL message is sent to the CLS 808, where user mobility service processing is achieved. The request is sent back to ANSI-41 home MSC 815, forwarded to the IMS network via PSTN-SIP gateway, and eventually delivered to the S-CSCF 825 as a SIP INVITE request. In one embodiment, the initial filter criterion to transfer the SIP INVITE to GRAS PDLS is set in the common PUID profile. The GWB SIP PDLS 810(3) may insert some information in the SIP header so that S-CSCF 825 can determine that the GRAS PDLS should not be contacted through a certain initial filter criterion condition since user mobility processing has been already invoked. In one embodiment, the GWB SIP PDLS 810(3) manages the Temporary SIP Gateway Number (like a TLDN going into SIP) for use in call deliveries into IMS.

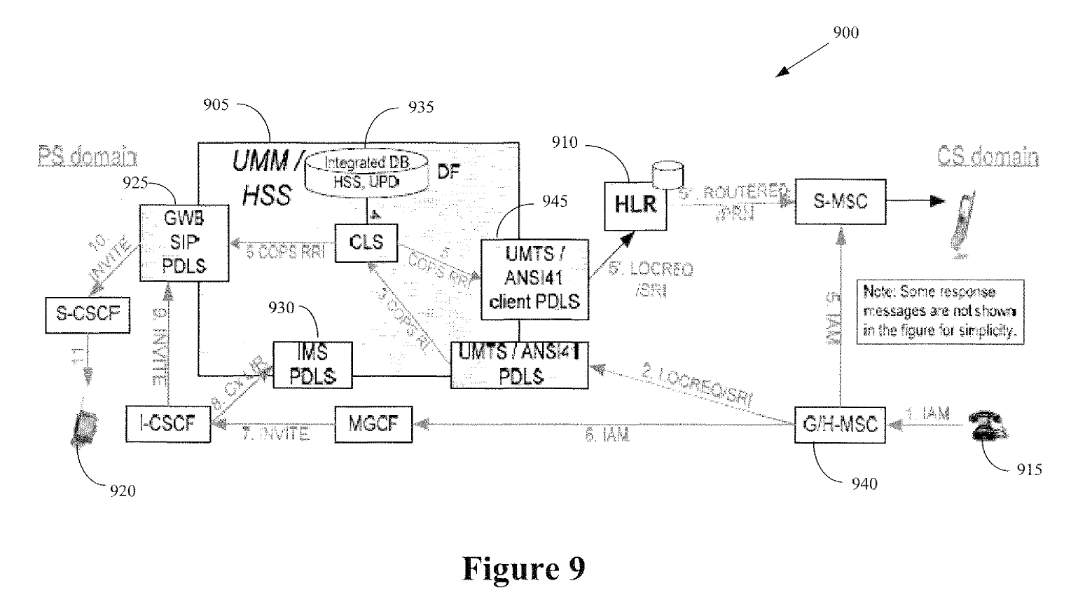

FIG. 9 conceptually illustrates communication pathways in a second exemplary embodiment of a wireless communication system 900. In the illustrated embodiment, the wireless communication system 900 is configured as a circuit switched (PSTN) origination deployment in UMM/HSS 905 with an external HLR 910. When a CS subscriber 915 originates a call to a PS subscriber 920, the SDHLR (which combines the UMM/HSS 905 and the external HLR 910) behaves as the ‘Home MSC’ of the calling CS subscriber 915 and the corresponding MSC related MAP messages may be added to the SDHLR. Additional functionality related to the GWB SIP PDLS 925 and the IMS PDLS 930 may be similar to the non-external HLR CS origination scenario depicted in FIG. 8. If the HSS 935 determines that the call delivery goes into IMS (that is, the PS subscriber 920 is roaming in IMS), then the external HLR 910 is not involved in the call and the Gateway Broker 925 generates a TGSN/TLDN which is passed back to the home MSC 940. If the HSS 905, 935 determines that the call delivery should not go to IMS, then the ANSI-41 client PDLS 445 forwards the LOCREQ to the external HLR 910. The data consistency between UMM/HSS 905 and HLR 910 can be enforced via the customer specific provisioning mechanisms.

In some embodiments, IMS application servers providing telephony-like features would benefit from HLR information such as call forwarding or call barring information. Additionally, updates should be available to the HLR and the circuit environment if a subscriber updates these settings in an IMS environment (e.g., forward-to number for call forwarding). Furthermore, it is a compelling idea to offer the best features of both WLAN and cellular networks to users by combining the small coverage area but low cost and high data rate of WLANs with the large coverage area of 2G, 2.5G, and 3G cellular networks albeit at lower data rates and higher costs compared to WLAN. Interworking WLANs with cellular networks expands the coverage area and brings immediate value to users with dual band cellular and WiFi handsets. Similarly, access via IMS provides the WiFi subscriber access to additional services, such as enterprises features, Push to Talk over Cellular services, and other advanced services. Some of the basic VoIP related interworking capabilities between 3G, WiFi and IMS are VoIP originations, VoIP terminations, VoIP feature transparency on shared voice mail system, SMSC, VoIP handoffs and VoIP supplementary features like call-forwarding, call-barring, number-identification, call-waiting, call-hold, 3-way calling, call-transfer, call-conferencing and the like. Embodiments of SDHLR/HSS that support unified subscriber profiles may provide a UMM solution that provides a good foundation for the consolidated database for a 3G-WiFi-IMS subscriber. The UMM/SDHLR's ability to provide a common subscriber database and interworking infrastructure may insure parity of the features between the Circuit and IP networks as well as across the different IMS access networks.

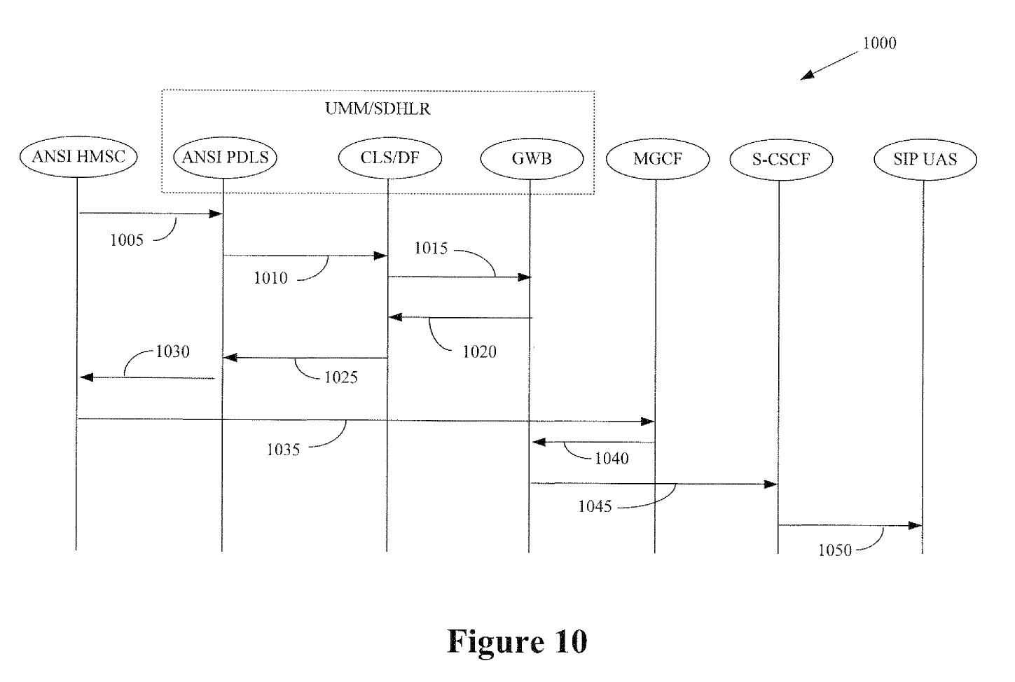

FIG. 10 conceptually illustrates one exemplary embodiment of a call flow 1000 that supports global roaming control. In the illustrated embodiment, the call flow 1000 illustrates GWB PDLS call scenarios that demonstrate roaming control between LTE/IM and cellular networks for cellular user access mode. However, persons of ordinary skill in the art having benefit of the present disclosure should appreciate that the call flow 1000 is intended to be illustrative and not to limit the claimed subject matter. In the illustrated embodiment, a user in the circuit-switched domain is attempting to establish a call session with a user in the packet-switched domain via its home mobile switching center (ANSI HMSC). The home mobile switching center sends (at 1005) a location request message to the universal mobility manager (UMM/SDHLR). The message is received by an ANSI PDLS that acts as the interface between the circuit-switched network and the UMM. The ANSI PDLS creates (at 1010) a protocol-independent query to the core logic server/database function (CLS/DF), which then sends (at 1015) a request to the GWB/PDLS, which responds (at 1020) with a TGSN.

The TGSN is transmitted (at 1025) from the core logic server to the ANSI PDLS, which returns (at 1030) this information to the home mobile switching center. The home mobile switching center transmits (at 1035) an IAM message including the TGSN to the gateway control function (MGCF) in the packet-switched network. The MGCF invites (at 1040) the GWB PDLS to join the session, e.g., using a SIP invite message, and then the GWB PDLS invites (at 1045, 1050) the S-CSCF and the SIP UAS to join the session. At this point a call session can be established between users in the circuit-switched domain and the packet-switched domain.

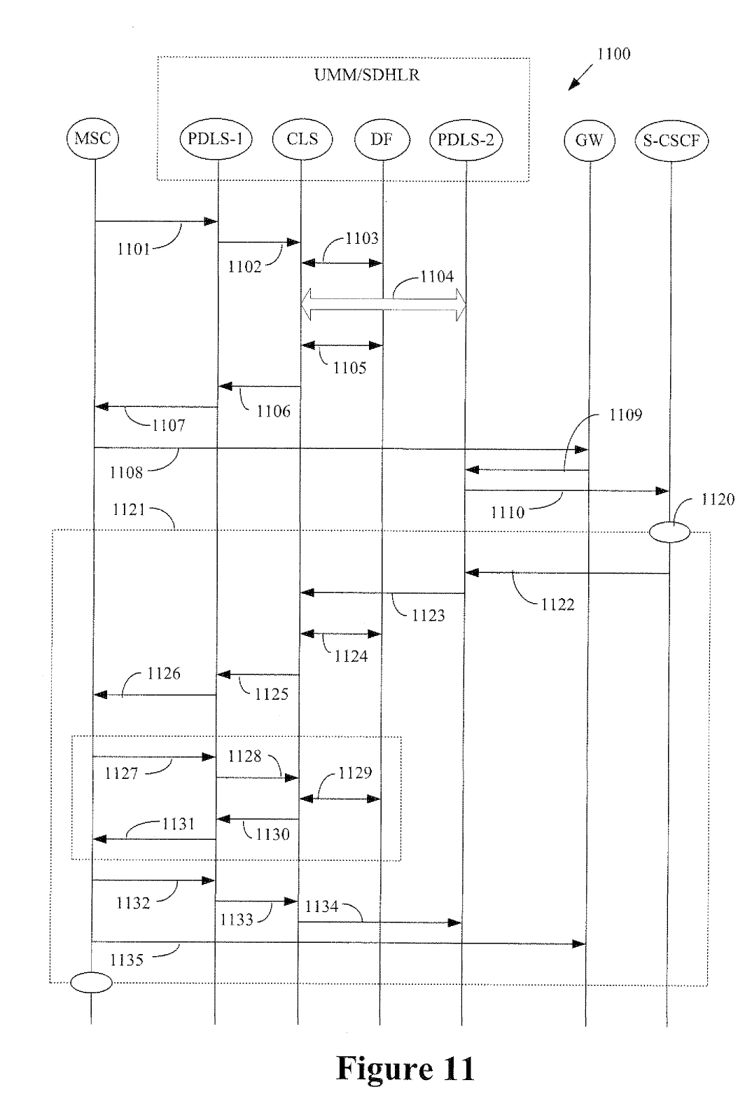

FIG. 11 conceptually illustrates one exemplary embodiment of a call flow 1100 to handle late call forwarding. In the illustrated embodiment, the call flow 1100 originates in a circuit-switched domain and is directed to a subscriber roaming in a packet-switched (e.g., IMS) domain. The original call is from the PSTN to a circuit-based subscriber roaming in IMS. In the illustrated embodiment, a mobile switching center in the circuit-switched domain provides (at 1101) a location request message to the UMM/SDHLR. When the LocReq message comes to SDHLR, the ANSI/UMTS PDLS sends (at 1102) the RL message to the core logic server (CLS). The CLS interacts (at 1103) with DF and then obtains (at 1104) a TSGN (temporary SIP Gateway Number) from the GWB/SIP PDLS. In embodiments where the call is delivered normally, the CLS interacts (at 1105) with the GWB/SIP PDLS to retain the call forwarding information that can be used to map the call forwarding signal. The TSGN is then sent (at 1106, 1107) to the ANSI MSC which in turn sends (at 1108) the IAM to the SIP GW or MGCF. The GW invites (at 1109) the GWB/SIP PDLS to the call session and invites (at 1110) the S-CSCF or SIP UAS to the call session. In the illustrated embodiment, the SIP UAS detects (at 1120) the Late Call Forwarding condition (which can be processed similarly even if SIP proxy/PDLS detects the condition), upon receiving the INVITE.

The call forwarding process (indicated in the dashed box 1121) proceeds after the call forwarding condition is detected (at 1120). After interactions (at 1122, 1123, 1124, 1125) between the GWB/SIP PDLS, CLS, DF and ANSI PDLS, a redirection request (REDREQ) is sent (at 1126) to the ANSI MSC. The ANSI MSC gets the late call forwarding number info (SIP/wireless/PSTN) from the SDHLR via a TRANUMREQ message that is sent (at 1127) from the ANSI MSC to the SDHLR, which then retrieves (1128, 1129, 1130) the requested information and returns (at 1131) it to the MSC. The ANSI MSC can forward (at 1132) a redirection request to the ANSI PDLS, which conveys (at 1133, 1134) this request to the CLS. The ANSI MSC also sends (at 1135) a release message to the SIP GW/MGCF. The ANSI MSC then sends (at 1136) the IAM message towards the Late CF destination number.

Embodiments of the techniques of implementing the cellular user access mode have a number of advantages over conventional practice. For example, embodiments of the cellular user access mode may provide:
user address information management (=address for a user, not for a terminal),
association to the potential destination candidate devices of various protocols,
common service data
Support for simultaneous registrations in multiple domains
cross domain presence detection and call delivery module with interworking capability.

Moreover, embodiments of the cellular user access mode may have a number of advantages in home networks such as:
Existing circuit-based service may not change when in circuit domain
Existing home and gateway MSCs can be used
Universal roaming interworking function and GRAS.
Subscriber service data consistency assurance scheme
Converged service creation and execution environment
Dynamic data consistency assurance across domains (data-level interworking)

Embodiments of the cellular user access mode may also have a number of advantages for visited networks such as:
Consistent user authentication mechanism
Mobile IP support
Seamless session hand-off across protocols, circuit-switched and packet-switched
Dual mode (e.g. WiFi and CDMA) terminal capability—Network selection and hand-over.

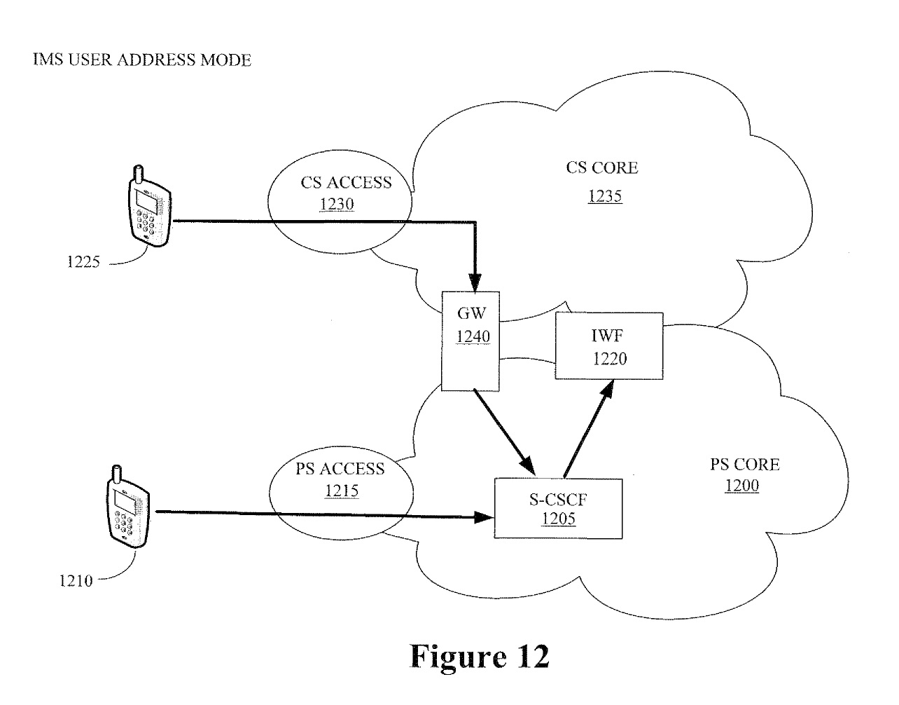

FIG. 12 conceptually illustrates global roaming using the IMS address mode. In the illustrated embodiment, subscriber destination numbers (DNs) are homed in the packet-switched core network 1200. For example, the DNs can be stored in an S-CSCF 1205 in the core network 1200. The S-CSCF 1205 is queried when a request for a user associated with a subscriber destination number is received from a user 1210 via a packet-switched access network 1215. The request can then be forwarded to the universal mobility manager interworking function 1220, which can use the destination number from the packet-switched network 1200 to locate the user and one or more devices, as discussed herein. Requests from users 1225 that are received via a circuit-switched access network 1230 and a circuit-switched core network 1235 can also be directed to the S-CSCF 1205 using a gateway 1240. The request can then be forwarded to the universal mobility manager 1220.

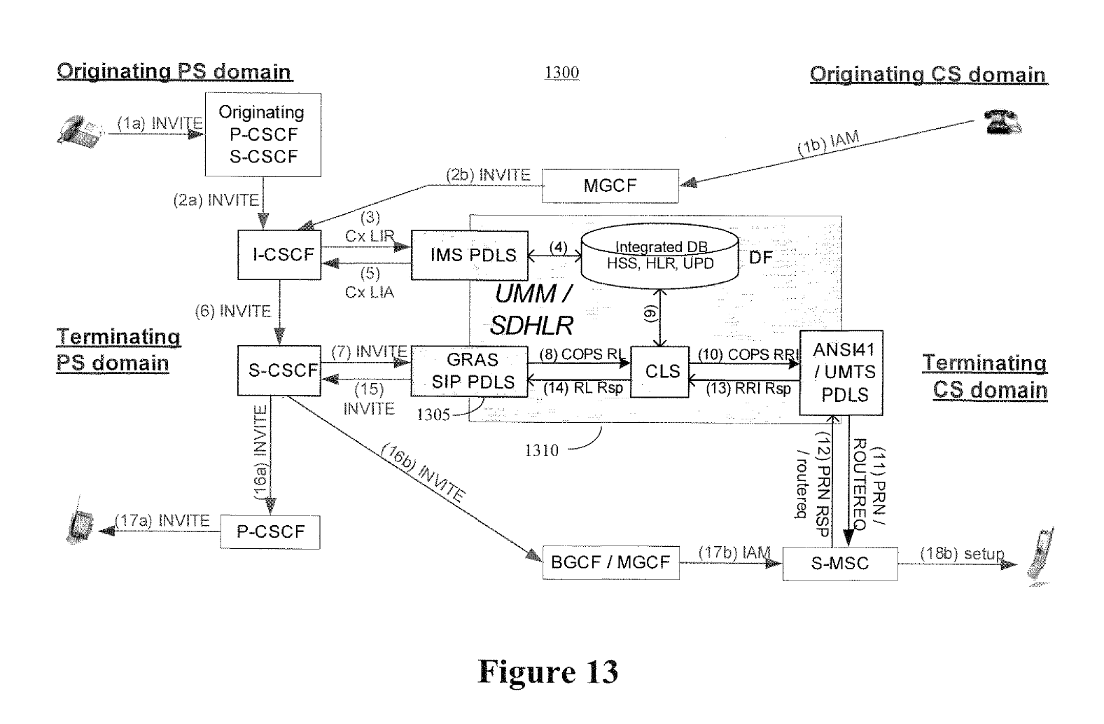

FIG. 13 conceptually illustrates communication pathways in a wireless communication system 1300. In the illustrated embodiment, the system 1300 implements a global roaming application server (GRAS) PDLS 1305 within UMM/SDHLR 1310. The GRAS PDLS 1305 may be used to support roaming of dual/multiple-mode access handsets between IMS/LTE and cellular network domains in the IMS User Address mode. The GRAS PDLS 1305 may help to route an IMS originated call using an IMS user address such as a public user ID. In the illustrated embodiment, the service logic of GRAS SIP PDLS 1305 terminates IMS ISC interface for UM enabled incoming call and translates the incoming SIP message into COPS RL request. The ISC interface is based on the SIP protocol. The GRAS SIP PDLS 1305 may be configured to accept several SIP messages, such as INVITE (SIP call routing request & SIP call setup signal), REGISTER, and MESSAGE, to support various types of global roaming interworking needs. The public user identity (A1@ims.com) is set in Request-URI in the INVITE. The GRAS SIP PDLS 1305 may also act as an IMS application server and interrogate HLR/HSS (within UMM/SDHLR) database to obtain presence information, and/or a temporary routing number, Temporary Local Directory Number (TLDN) or Mobile Station Roaming Number (MSRN), for CS domain.

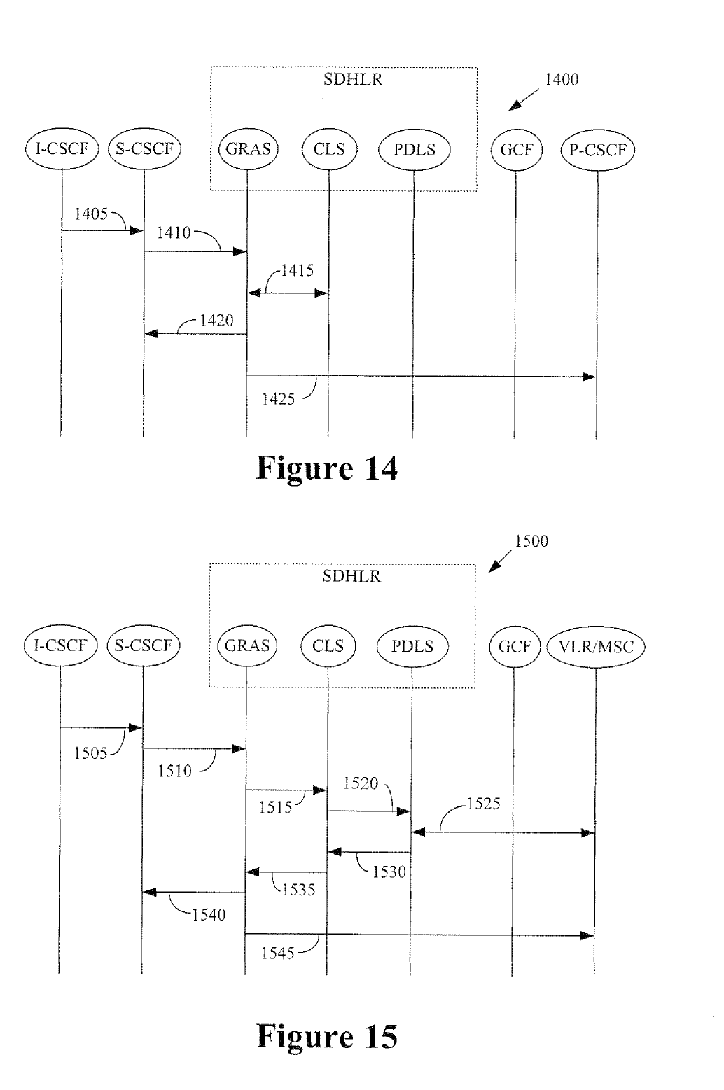

FIG. 14 conceptually illustrates a first exemplary embodiment of a method 1400 for roaming control between LTE/IMS and cellular networks in the IMS user access mode. In the illustrated embodiment, the user is roaming from a circuit domain to a packet-switched (IMS) network and the user equipment is only registered in the packet-switched domain. An invite message including a packet-switched domain identifier PUID is first transmitted (at 1405) to the I-CSCF, which forwards (at 1410) this message to the GRAS PDLS in the SDHLR. The invite message includes information identifying the user equipment, such as the public user ID. The GRAS PDLS communicates (at 1415) with the core logic server and determines that the user is only registered in the IMS packet-switched domain. The GRAS PDLS returns (at 1420) an invite message to the S-CSCF with the public user ID and the S-CSCF sends (at 1425) an invite message with the public user ID to the P-CSCF in the IMS network.

FIG. 15 conceptually illustrates a second exemplary embodiment of a method 1500 for roaming control between LTE/IMS and cellular networks in the IMS user access mode. In the illustrated embodiment, the user is roaming from a circuit domain to a circuit-switched (CDMA) network when the user equipment is only registered in the circuit-switched domain. An invite message including a packet-switched domain identifier PUID is first transmitted (at 1505) to the I-CSCF, which forwards (at 1510) this message to the GRAS PDLS in the SDHLR. The invite message includes information identifying the user equipment, such as a PUID. The GRAS PDLS communicates (at 1515) with the core logic server and determines that the user is only registered in the CDMA circuit-switched domain. The core logic server notifies (at 1520) the ANSI PDLS, which exchanges (at 1525) route request messages with the mobile switching center in the visited network. A response is provided (at 1530) from the core logic server to the GRAS. In the illustrated embodiment, the response includes a circuit-switched identifier such as a TLDN. The GRAS returns (at 1535) an invitation with the TLDN to the S-CSCF and the S-CSCF sends (at 1540) an invite message with the TLDN to the MGCF and the MSC.

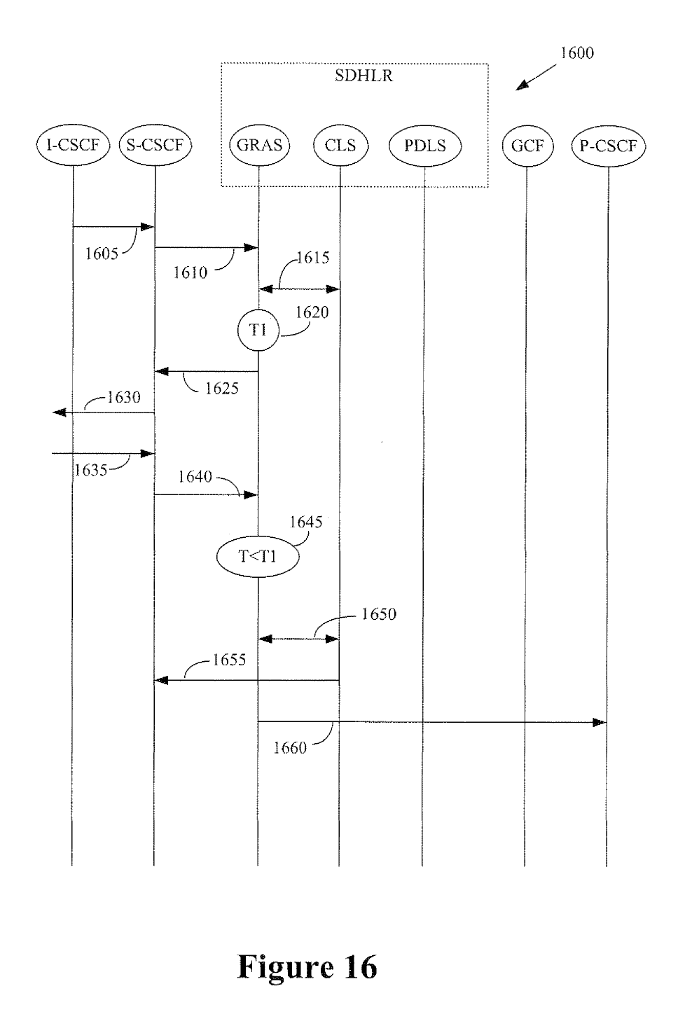

FIG. 16 conceptually illustrates a third exemplary embodiment of a method 1600 for roaming control between LTE/IMS and cellular networks in the IMS user access mode. In the illustrated embodiment, the user is roaming from a circuit domain to a packet-switched (IMS) domain and the user equipment is registered in the circuit-switched domain and the packet-switched domain. An invite message including a packet-switched domain identifier PUID is first transmitted (at 1605) to the I-CSCF, which forwards (at 1610) this message to the GRAS PDLS in the SDHLR. The GRAS PDLS communicates (at 1615) with the core logic server and determines that the user is registered in the CDMA circuit-switched domain and the IMS packet-switched domain. The GRAS PDLS returns (at 1625, 1630) an options message to the S-CSCF with the public user ID to check if the user equipment is reachable in the IMS domain. In the illustrated embodiment, the GRAS sets (at 1620) a timer T1 and then waits to receive a response. The S-CSCF receives (at 1635) a positive response from the user equipment and the S-CSCF sends (at 1640) a positive response with the public user ID to the GRAS. Since the positive response was received (at 1645) within the time T1, the GRAS PDLS determines (at 1650) the PUID in the visited network and returns (at 1655) an invite message to the S-CSCF with the visited PUID and the S-CSCF sends (at 1660) an invite message with the public user ID to the P-CSCF in the IMS network.

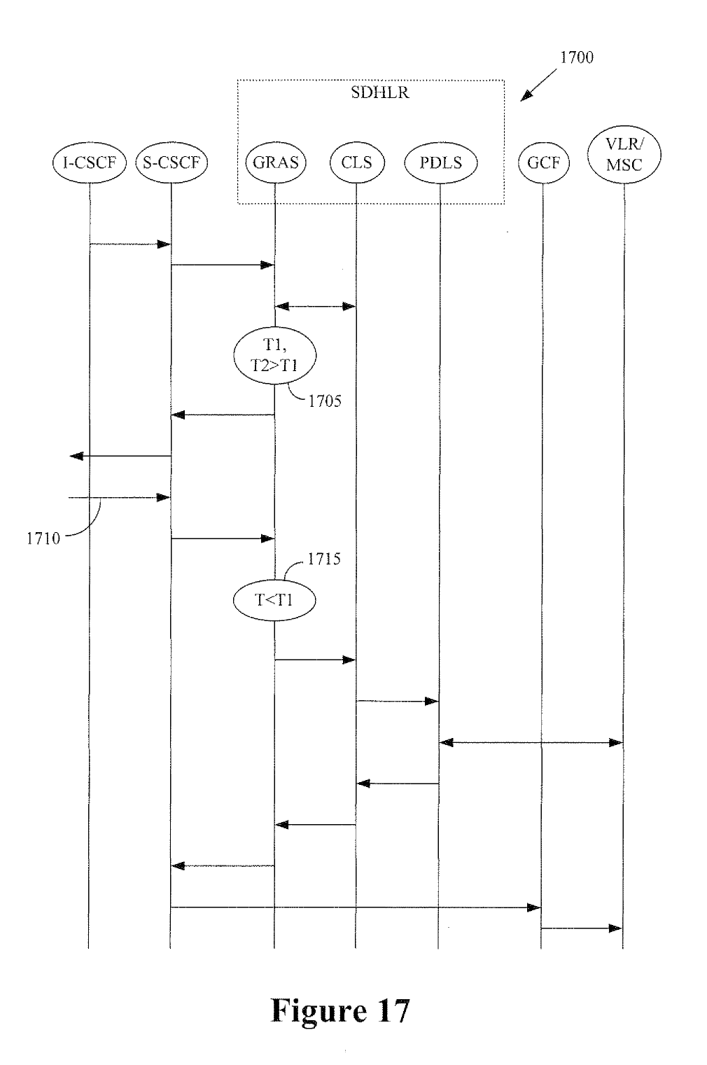

FIG. 17 conceptually illustrates a fourth exemplary embodiment of a method 1700 for roaming control between LTE/IMS and cellular networks in the IMS user access mode. The fourth exemplary embodiment is similar to the third exemplary embodiment but differs from the third exemplary embodiment in several ways. In the fourth exemplary embodiment, a first timer is set to T1 and a second timer is set to T2>T1 (at 1705). A negative response is received (at 1710) from the user equipment indicating that the user equipment is not available in the IMS packet-switched network and is only available in the CDMA network. The negative response is received at a time T<T1 and so the SDHLR proceeds with the invitation process for the CDMA network, such as described in the other embodiments herein.

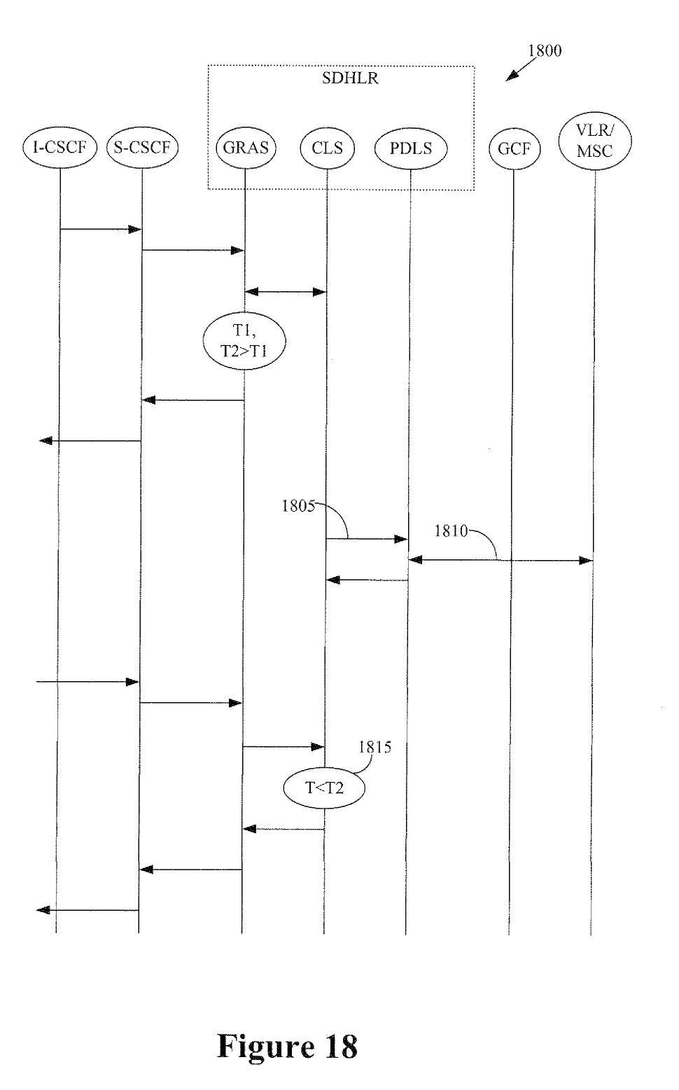

FIG. 18 conceptually illustrates a fifth exemplary embodiment of a method 1800 for roaming control between LTE/IMS and cellular networks in the IMS user access mode. The fifth exemplary embodiment is similar to the fourth exemplary embodiment but differs from the fourth exemplary embodiment in several ways. In the fifth exemplary embodiment, no response is received from the user equipment within the time T1 counted down by the first timer. The core logic server notifies (at 1805) the ANSI PDLS, which exchanges (at 1810) route request messages with the mobile switching center in the visited network. However, after the time T1 and before the time T2, a positive response to the option message is received (at 1815). Regardless of the result of the CDMA route request, the SDHLR proceeds with the invitation process to the IMS network. The IMS domain may therefore be given priority over the CDMA domain in this embodiment.

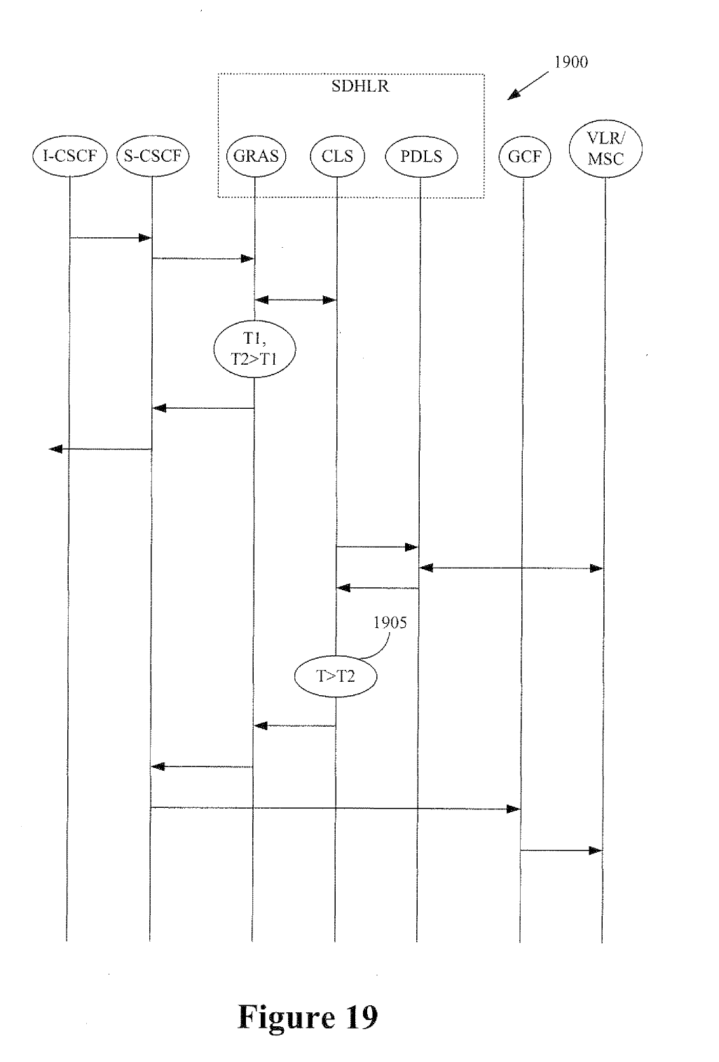

FIG. 19 conceptually illustrates a sixth exemplary embodiment of a method 1900 for roaming control between LTE/IMS and cellular networks in the IMS user access mode. The sixth exemplary embodiment is similar to the fifth exemplary embodiment but differs from the fifth exemplary embodiment in several ways. In the sixth exemplary embodiment, no response is received from the user equipment within the time T1 or the time T2. The SDHLR therefore proceeds (at 1905) with the invitation process for the CDMA network, such as described in the other embodiments herein.

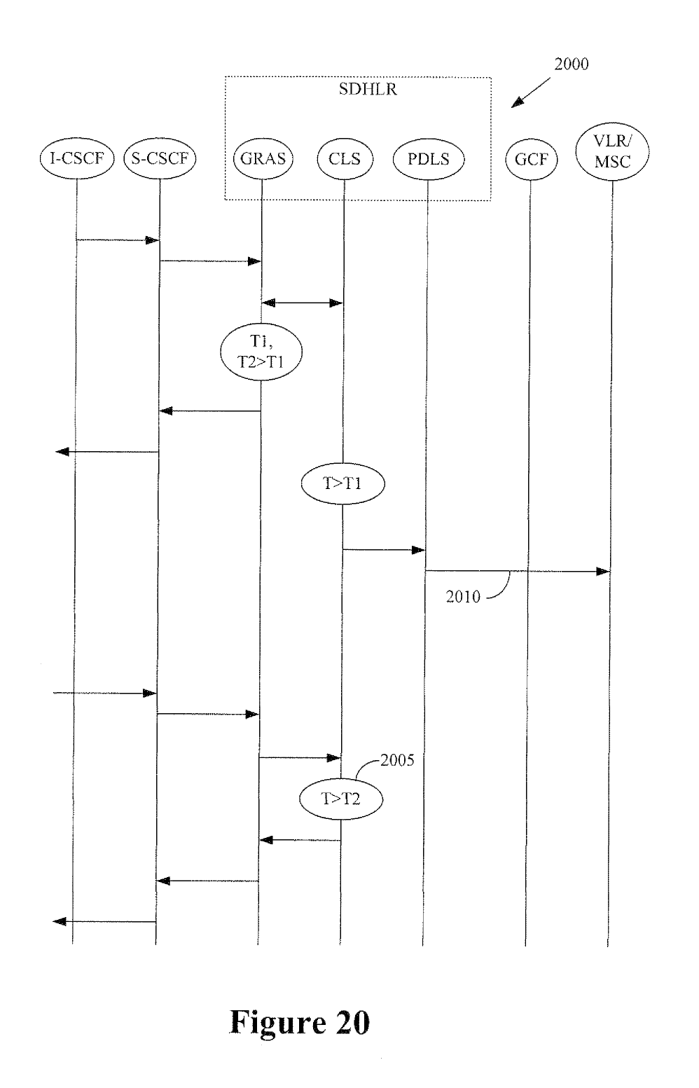

FIG. 20 conceptually illustrates a seventh exemplary embodiment of a method for roaming control between LTE/IMS and cellular networks in the IMS user access mode. The seventh exemplary embodiment is similar to the sixth exemplary embodiment but differs from the sixth exemplary embodiment in several ways. In the seventh exemplary embodiment, the core logic server receives (at 2005) a positive response from the user equipment indicating that it is available in the IMS network before the core logic server receives a response to the route request message transmitted (at 2010) to the MSC in the CDMA network. Since the SDHLR has received a positive response, the SDHLR proceeds with the invitation process to the IMS network.

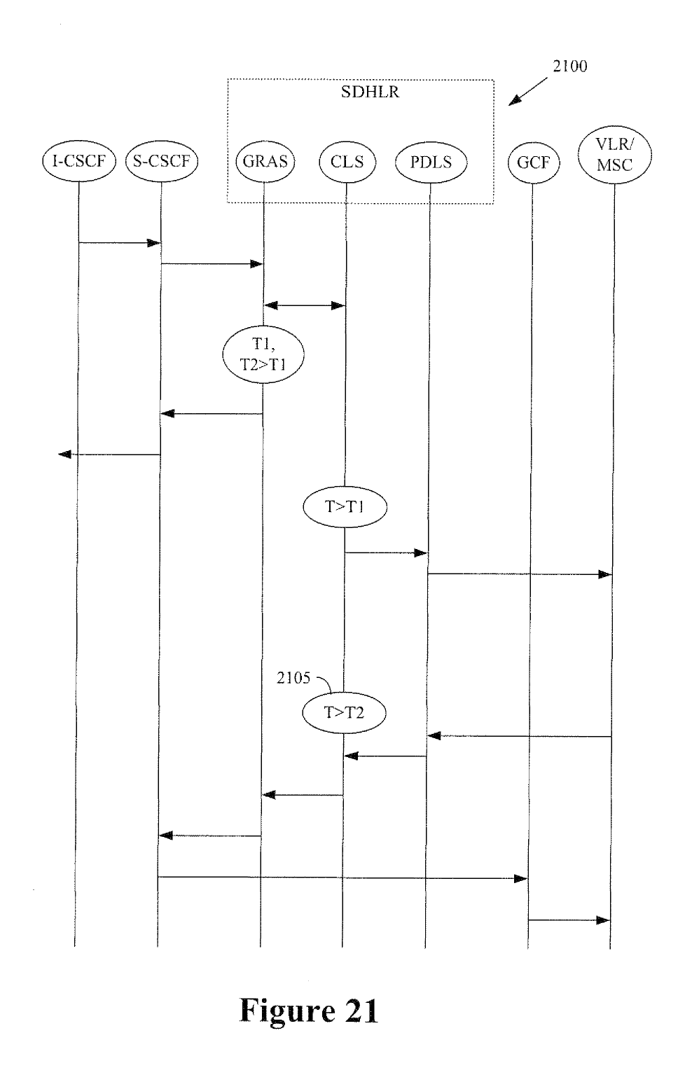

FIG. 21 conceptually illustrates an eighth exemplary embodiment of a method 2100 for roaming control between LTE/IMS and cellular networks in the IMS user access mode. The eighth exemplary embodiment is similar to the seventh exemplary embodiment but differs from the seventh exemplary embodiment in the following ways. In the eighth exemplary embodiment, the core logic server does not receive a response from the user equipment within the time T2 but does receive (at 2105) a response from the CDMA network. The SDHLR therefore proceeds with the invitation process for the CDMA network, such as described in the other embodiments herein. In one embodiment, an error message may be returned in the user equipment is registered in both the IMS and CDMA network at the core logic server does not receive a response from the user equipment or a response from the MSC in the CDMA network.

Embodiments of the IMS user access mode described herein have a number of benefits over conventional practice. Embodiments of these techniques provide:
user address information management (=address for a user, not for a terminal),
association to the potential destination candidate devices of various protocols,
common service data
cross-domain presence detection and call delivery module with interworking capability.

Embodiments of the IMS user access mode may also enable the following for home networks:
Universal roaming interworking function and GRAS.
Subscriber service data consistency assurance scheme
Converged service creation and execution environment
Dynamic data consistency assurance across domains (data-level interworking)

Embodiments of the IMS user access mode may further enable the following for visited networks:
Consistent user authentication mechanism
Mobile IP support
Seamless session hand-off across protocols, circuit-switched and packet-switched
Dual mode (e.g. WiFi and CDMA) terminal capability—Network selection and hand-over.

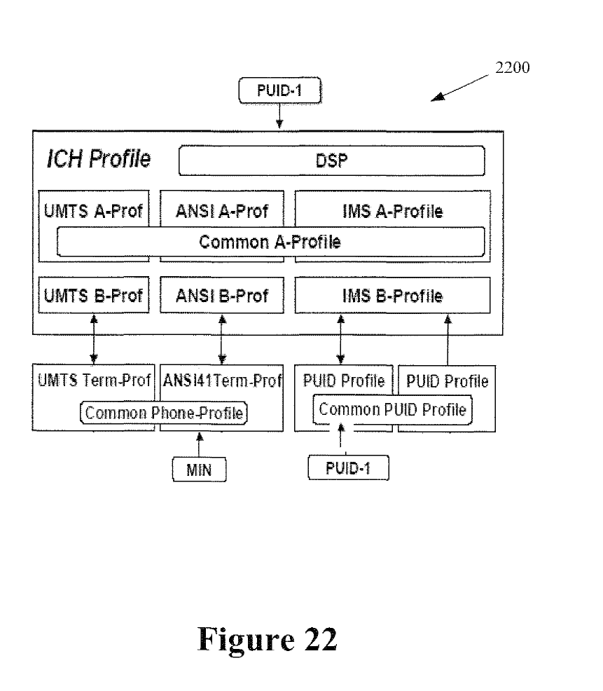

FIG. 22 conceptually illustrates one exemplary embodiment of a caller profile 2200 for a dual-mode phone with IMS and ANSI-41 capabilities. SIP URI (PUID-1) and E.164 number with PUID form (PUID-1a) and DN form (MDN-1) are assigned to this user. The destination candidate is an ANSI terminal represented as MIN-1, and an IMS end-point represented as PUID-1. FIG. 22 also shows the corresponding UMM subscriber model. MDN is listed as a callable address, which would be necessary when the existing ANSI-41 core network is reused in the service provider's network. If the entire core network is transitioned to the one with IMS architecture, then MDN won't be necessary in the callable address. In UMM/SDHLR based IMS to CDMA roaming solution, the GRAP SIP PDLS acts as the ‘Home MSC’ for the Packet Switched Origination Call and gets the destination related information about the CS called party subscriber. The public user identity (A1@ims.com) is set in Request-URI in the INVITE. In this case, a filter criterion is set in S-CSCF for the call to be relayed to the GRAS PDLS. The FIG. 6 shows that the GRAS SIP PDLS terminates IMS ISC (SIP) interface and translates the incoming SIP message into COPS RL request. For the S-MSC, the GRAP SIP PDLS acts like a logical ‘Home MSC’ of the PS calling party subscriber, but no new MAP messages need to be added. The GRAP SIP PDLS gets the TLDN and passes it to the S-CSCF which then terminates the call to the CS called party subscriber. Note that this scenario can peacefully coexist with the legacy circuit-based home MSC, since it is not required in ANSI-41 that all LOCREQs for one subscriber must come from the same “MSC

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
selecting, at a mobility manager in response to receiving a request from a first gateway in an originating domain to locate a user, a first routing number that identifies the mobility manager as a gateway to the originating domain;
identifying, at the mobility manager, a second gateway that serves the user in a destination domain using a first user identifier included in the request received from the first gateway; and
storing, in the mobility manager, information associating the first routing number with a second routing number that identifies the second gateway.

2. The method of claim 1, comprising establishing, at the mobility manager, a bearer between the first gateway and the second gateway by mapping the first routing number to the second routing number using the stored information.

3. The method of claim 2, comprising releasing the first routing number so that it can be selected to identify the mobility manager to the originating domain in response to receiving a subsequent request to locate another user.

4. The method of claim 1, wherein the originating domain is a circuit-switched domain, and wherein selecting the first routing number comprises selecting a first routing number that identifies a first interface between the first gateway and the mobility management as a gateway that operates according to circuit-switched protocols.

5. The method of claim 4, wherein the destination domain is a packet-switched domain, and wherein identifying the second gateway that serves the user in the packet-switched domain comprises identifying a second user identifier that identifies the user in the packet-switched domain based on the first user identifier that identifies the user in the circuit-switched domain.

6. The method of claim 4, comprising transmitting, from the mobility manager to the first gateway, a request to redirect a call from the originating domain to the user in the destination domain when a forwarding condition has been detected for the user.

7. The method of claim 6, comprising receiving, at the mobility manager from the first gateway, a request for a call forwarding number.

8. The method of claim 7, comprising retrieving the call forwarding number from a database in the mobility manager and forwarding the call forwarding number to the first gateway.

9. The method of claim 1, wherein the originating domain is a packet-switched domain, and wherein selecting the first routing number comprises selecting a first routing number that identifies a first interface between the first gateway and the mobility manager as a gateway that operates according to packet-switched protocols.

10. The method of claim 9, wherein the destination domain is a circuit-switched domain, and wherein identifying the second gateway that serves the user in the circuit-switched domain comprises identifying a second user identifier that identifies the user in the circuit-switched domain based on the first user identifier that identifies the user in the packet-switched domain.

11. The method of claim 10, wherein the user is registered in the circuit-switched domain and the packet-switched domain, and comprising determining whether the user is reachable in at least one of the circuit-switched domain or the packet-switched domain.

12. The method of claim 11, wherein determining whether the user is reachable comprises providing a first message to the packet-switched domain and determining that the user is reachable if the packet-switched domain provides a positive response within a first time interval.

13. The method of claim 12, wherein determining whether the user is reachable comprises providing a second message to the circuit-switched domain following expiration of the first time interval and determining that the user is reachable if the circuit-switched domain provides a positive response within a second time interval.

14. The method of claim 1, comprising accessing presence information stored by the mobility manager, the presence information indicating whether the user is present in the destination domain.

15. The method of claim 1, wherein identifying the second gateway comprises converting the request into a domain-independent query to a database in the mobility manager and querying the database for a user profile including information indicating the second gateway associated with the user.

16. The method of claim 1, wherein selecting the first routing number comprises selecting a temporary routing number drawn from a pool maintained at the mobility manager.

17. The method of claim 1, wherein identifying the second gateway comprises identifying one of a plurality of terminals associated with the user based on a destination selection policy.

18. A protocol dependent logic server configured to:
select, in response to receiving a request from a circuit-switched domain to originate a call to a user in a packet-switched domain, a first routing number that identifies the protocol dependent logic server as a gateway to the circuit-switched domain;
map a directory number associated with the user in the circuit-switched domain to a public identifier in the packet-switched domain; and
route the call from the circuit-switched domain to the packet-switched domain using the first routing number, the directory number, and the public identifier.

19. The protocol dependent logic server set forth in claim 18, wherein the protocol dependent logic server is further configured to select the first routing number from a pool of temporary routing numbers and return the first routing number to the pool after the call has been routed to the packet-switched domain.

20. A protocol dependent logic server configured to:
determine, in response to receiving a request from a packet-switched domain to originate a call to a user in a destination domain, whether the destination domain is a circuit-switched domain or a packet-switched domain;
route the call using a public identifier included in the request when the destination domain is a packet-switched domain; and
route the call using a temporary directory number selected by the protocol dependent logic server when the destination domain is a circuit-switched domain.
